(19) United States
(12) Patent Application Publication
(10) Pub. No.: US 2025/0328391 A1
(43) Pub. Date: Oct. 23, 2025

(54) Predictive Scale-Up Of Compute Nodes In A Software Orchestration Cluster

(71) Applicant: NetApp, Inc., San Jose, CA (US)

(72) Inventors: Vladislav Chourilov, Sderot (IL); Orel Or Leshno Fish, Tel Aviv (IL); Tal Shmuel Shafir, Yavne (IL); Oren Gurfinkel, Rishon Le Zion (IL)

(73) Assignee: NetApp, Inc., San Jose, CA (US)

(21) Appl. No.: 18/637,593

(22) Filed: Apr. 17, 2024

(51) Int. Cl. G06F 9/50

(52) U.S. Cl. CPC G06F 9/5044; G06F 9/5055

(57) ABSTRACT

The disclosure describes a node management service that proactively scales up compute nodes in a compute cluster. The node management service interfaces with an orchestration service, a compute provider and a compute cluster running instances of an object. The node management service receives meta data from an orchestration service indicating the desired number of instances of an object. Based on the desired number of instances, the node management service obtains, from the compute provider, new compute nodes for the compute cluster to accommodate the desired number of instances.

### TECHNICAL FIELD

The disclosure relates to a node management service, and more specifically to predictive scaling of compute nodes in a compute cluster.

### BACKGROUND

Compute providers offer compute resources to developers and application owners for running applications. Since application usage changes over time (e.g., due to varying amounts of user traffic throughout a day) the amount of compute power needed to run a specific application tends to fluctuate. Customers utilize an orchestration service such as Kubernetes to scale the allocated computing resources for an application.

An orchestration service adjusts to changing demand by increasing or decreasing the number of object instances (e.g., pod replicas including one or more software containers) in a cluster. To increase the number of instances, the orchestration platform first creates new instances by adding a dataset for each instance to an instance registry. The orchestration service then schedules each created instance to a compute node in a node cluster, where the compute nodes may be Virtual Machines (VMs) allocated to the cluster by the infrastructure provider. Finally, each instance of the object is deployed to the compute node on which it has been scheduled.

A node management service, working in conjunction with the orchestration service, manages the number of compute nodes in the cluster. Specifically, the node management service requests new nodes from an infrastructure provider to meet higher demands. For example, if the cluster requires new nodes to accommodate objects in a new version of an application, the infrastructure management service scales up new compute nodes by submitting a request to the infrastructure provider.

There may be a high number of replicated instances (e.g., tens of thousands) for a given application, the creation of which is a time-consuming process. In some cases, the creation of the objects may take forty minutes or more. Once the instances are created, the orchestration service attempts to schedule the instances. The orchestration service will be unable to schedule an instance if there is not a compute node in the node cluster with sufficient available compute resources to accommodate the instance. This creates further delays since it takes time for the infrastructure management service to scale up new compute nodes.

### SUMMARY

The technology described herein includes a node management service that proactively scales up compute nodes in a compute cluster, thereby mitigating or eliminating the delays described above. The node management service interfaces with an orchestration service, a compute provider, and a compute cluster. The node management service receives meta data from an orchestration service indicating a desired number of instances of an object to be scaled-up on the compute cluster. The node management service proactively obtains new compute nodes from the compute provider to accommodate the desired number of instances, even ahead of their full creation.

Some examples of a method of operating a node management service include generating a user interface for display to an owner of an application deployed on the compute nodes in the compute cluster. The compute nodes are provided by the compute provider and managed by the node management service. The user interface includes an element allowing the owner to enable a predictive scaling feature of the node management service. The method further includes, in response to a scale-up event, determining whether the predictive scaling feature is enabled for the application. The method further includes, in response to determining that the predictive scaling feature is enabled for the application, applying the predictive scaling feature to the application.

This Summary introduces a selection of concepts in a simplified form that are further described below in the Technical Disclosure. It may be understood that this Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a computing environment in an implementation.

FIG. 2 illustrates a node scaling process in an implementation.

FIG. 3 illustrates an operational sequence in an implementation.

FIG. 4 illustrates another computing environment in an implementation.

FIG. 5 illustrates another node scaling process in an implementation.

FIG. 6 illustrates another operational sequence in an implementation.

FIG. 7 illustrates a user interface in an implementation.

FIG. 8 illustrates a computing system suitable for implementing the various operational environments, architectures, environments, processes, scenarios, sequences, and frameworks discussed below with respect to the other Figures.

### DETAILED DESCRIPTION

A node management service is disclosed herein that obtains compute nodes ahead of the creation of object instances by an orchestration service. The node management service obtains the compute nodes in response to meta data read from the orchestration service that identifies a desired number of instances to run in a compute cluster. The orchestration services utilize the metadata to maintain the desired number of instances running in the compute cluster. Orchestration service creates new instances (by updating an instance registry) when the desired number of instances is less than the number of instances running in the compute cluster. By reading the meta data in advance, node management can anticipate new instances that will be created by the orchestration service.

Node management service obtains the compute to accommodate newly created instances. While the orchestration service progresses through the task of creating the instances—to be deployed to a compute cluster managed by the node management service—the node management service obtains or otherwise secures the compute from a compute provider. In this manner, sufficient compute resources are available in the cluster to accommodate the objects upon their creation by the orchestration service.

Such an implementation may be especially advantageous in the context of large-scale object deployments (e.g., where there are hundreds, thousands, or more instances) where the current capacity would not suffice for the entirety of the deployment. In the past, the node management service would procure additional compute nodes to meet the demands of the object scale-up post-creation once the orchestration service had created them in an instance registry and had begun to schedule their deployment. As mentioned above, the creation of the instances by the orchestration service can take substantial amounts of time. By obtaining the necessary compute ahead of time, the concepts disclosed herein at least narrow the amount of time required to deploy the objects to the cluster since sufficient compute will be available.

Various embodiments of the present technology provide for a wide range of technical effects, advantages, and/or improvements to computing systems and components. For example, various embodiments may include one or more of the following technical effects, advantages, and/or improvements: 1) non-routine and unconventional dynamic implementation of cluster management; 2) non-routine and unconventional operations for obtaining compute capacity in a proactive manner; 3) dynamic modifying the capacity of a cluster to which orchestrated objects may be deployed; and 4) non-routine and unconventional use of meta data provided by orchestration services.

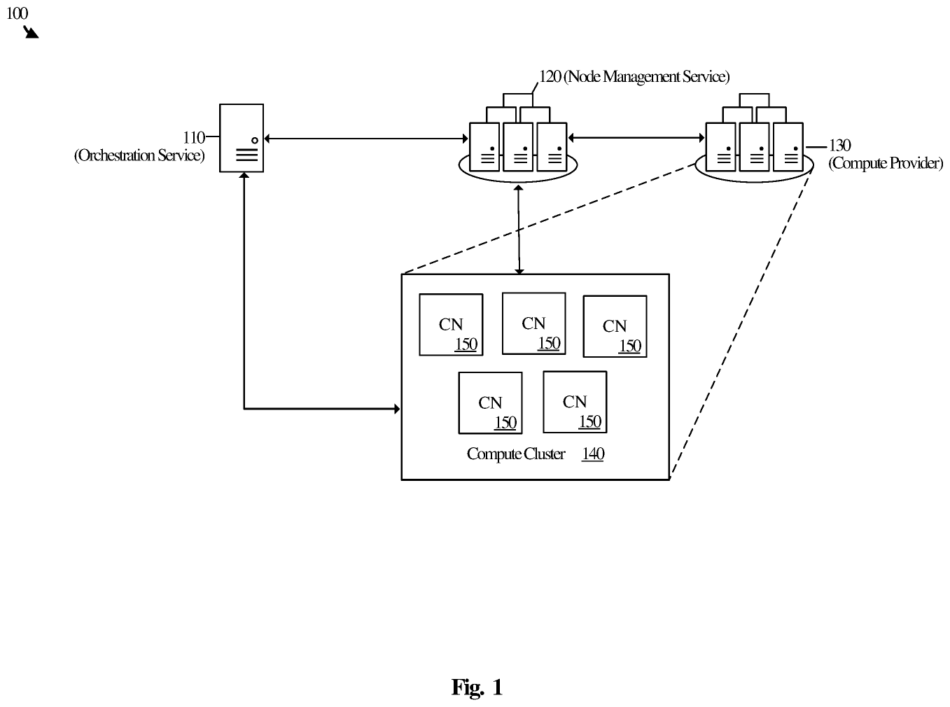

FIG. 1 illustrates compute environment 100 in an implementation. Compute environment 100 includes orchestration service 110, node management service 120, compute provider 130, and compute cluster 140. Compute cluster 140 includes compute nodes 150.

Orchestration service 110 is representative of a software service that orchestrates deployment of an application in compute cluster 140. Examples of orchestration service 110 include Kubernetes, Nomad, and Apache Mesos, among others.

Node management service 120 is representative of a service that manages compute nodes 150 in compute cluster 140. Node management service 120 may be, for example, Spot Ocean.

Compute provider 130 is representative of a provider of compute resources, including compute nodes 150 for compute cluster 140. Examples of compute provider 130 include Amazon Web Services, Google Cloud, and IBM Cloud.

Compute cluster 140 is a cluster of compute nodes 150, where each compute node 150 may be a VM provided by compute provider 130. Compute nodes 150 in compute cluster 140 are managed by node management service 120. Node management service 120 scales up and down compute nodes 150 to achieve the appropriate amount of compute resources for compute cluster 140.

Orchestration service 110 is in communication with node management service 120 and compute cluster 140. Orchestration service 110 is optionally in communication with compute provider 130. Node management service 120 is in communication with orchestration service 110, compute provider 130, and compute cluster 140.

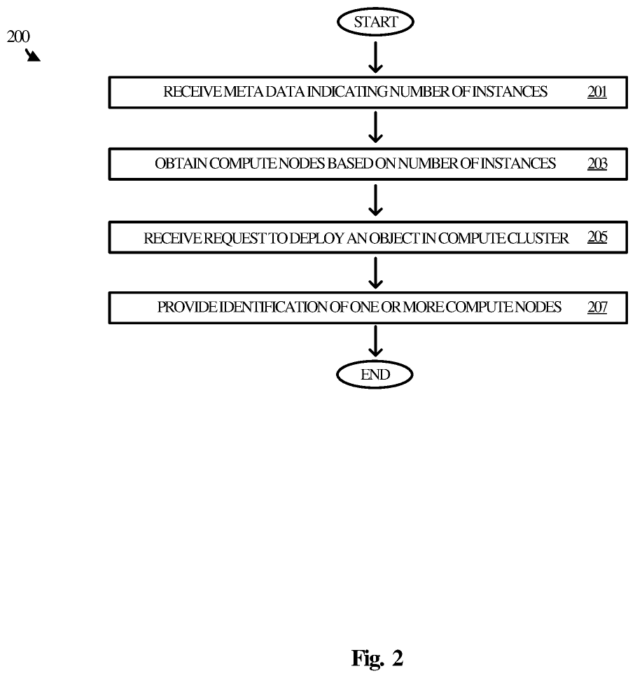

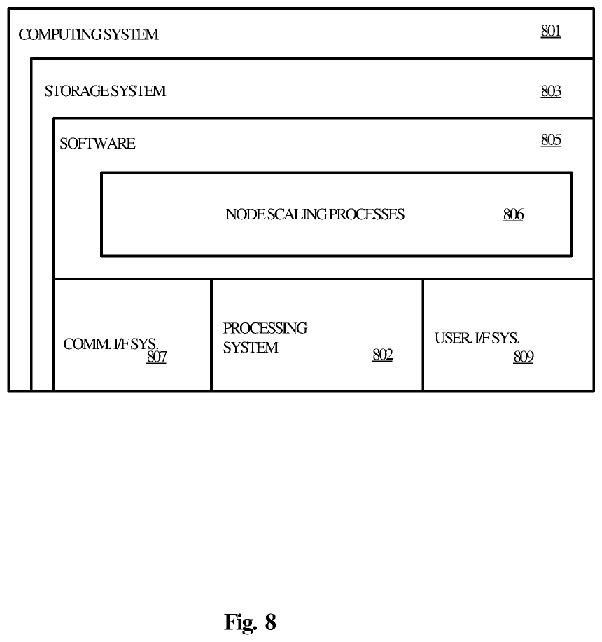

FIG. 2 illustrates a node scaling process performed by node management service 120, represented by process 200. Process 200 is employed by a computing device to provide node scaling, an example of which is provided by computing system 801 of FIG. 8. Process 200 may be implemented in program instructions (software and/or firmware) by one or more processors of the computing device. The program instructions direct the computing device to operate as follows, referring parenthetically to the steps in FIG. 2.

To begin, node management service 120 receives, from orchestration service 110, meta data indicating a number of instances of an object to scale up on compute nodes 150 of compute cluster 140 (step 201). Receiving the meta data may be in response to node management service 120 submitting a request for the meta data to orchestration service 110 (e.g., via an API server of orchestration service 110).

Node management service 120 then obtains one or more new compute nodes 150 from compute provider 130 based on the number of instances (step 203). Obtaining the one or more compute nodes may include, for example, submitting a request for VMs from compute provider 130. The request may specify, for example, the VM type, the VM size, and the Operating System image, among other settings. Node management service 120 receives, from compute provider 130, an identification of each VM provisioned in response to the request. Obtaining compute nodes 150 may further include deploying a node agent (e.g., Kubelet) to the compute nodes 150 and registering compute nodes 150 with a master controller of compute cluster 140.

After obtaining the new compute nodes, node management service 120 receives a request from orchestration service 110 to deploy at least one instance of an object in compute cluster 140 (step 205).

Node management service 120 provides, to orchestration service 110 in response to the request, an identification of one of the one or more compute nodes 150 deploy the instance(s) of the object (step 207).

Once orchestration service 110 receives the identifications of compute nodes 150, orchestration service 110 schedules new instances (e.g., instances created to achieve the desired number of instances defined in meta data) by assigning each new instance to a compute node 150, then deploys each instance to its assigned compute nodes 150.

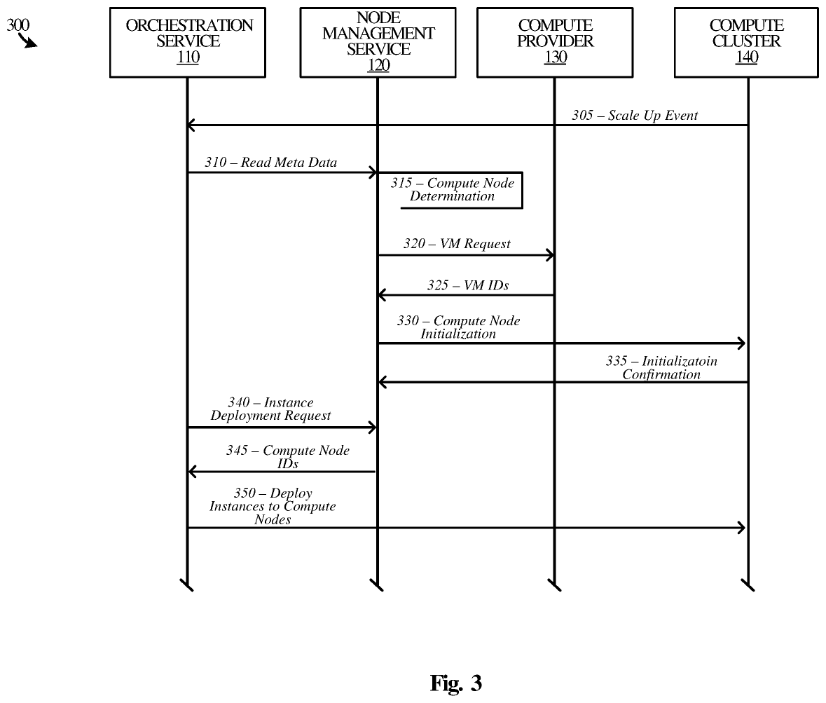

FIG. 3 illustrates an operation sequence of an application of process 200 in the context of compute environment 100 in an implementation, represented by sequence 300.

To begin, orchestration service 110 receives an indication of a scale-up event from compute cluster 140 (operation 305). Node management service 120 reads meta data from orchestration service 110, where the meta data indicates the number of instances of an object to scale up (operation 310). Node management service 120 reads the meta data, for example, by submitting a request for the metadata via an API server of orchestration service 110.

Node management service 120 determines to obtain new compute nodes based on the number of instances (operation 315). The determination to obtain new compute nodes is based on a determination that compute cluster 140 does not currently include sufficient compute resources to accommodate the number of instances in the meta data. For example, if the meta data defines the desired number of instances as one-thousand for an object, node management service may determine that the compute nodes 150 in compute cluster 140 do not currently have sufficient resources to accommodate all one-thousand instances. At operation 315, node management service 120 determines a number and size of the new compute nodes to accommodate all pending instances.

Node management service 120 then submits, to compute provider 130, a request for virtual machines (operation 320). Specifically, node management service 120 submits a request for VMs according to the number and size of the new compute nodes that node management service 120 determined to obtain at operation 315. The request may specify, for each VM requested, the VM type, the VM size, and the Operating System image, among other settings.

Compute provider 130 provides, to node management service 120, identifications of virtual machines (VMs) provisioned by compute provider 130 in response to the request from node management service 120. (operation 325).

Node management service 120 then initializes the new compute nodes 150 in compute cluster 140 (operation 330). Initializing new compute nodes 150 may include, for example, registering each of the provisioned VMs with compute cluster 140 and deploying a node agent to run in each of the VMs.

Compute cluster 140 responds to node management service 120 with a confirmation of initialization (operation 335). The confirmation of initialization may include an indication that the new compute nodes 140 are initialized and ready to run object instances.

Node management service 120 then receives a deployment request from orchestration service 110 (operation 340). The deployment request may be an indication that one or more newly created instances in orchestration service 110 are ready for scheduling. Node management service may receive this indication by monitoring an instance registry of orchestration service 110.

In response, node management service 120 provides orchestration service 110 with an identification of the new compute node (operation 345), where the new compute nodes are the compute nodes initialized at operation 335. Orchestration service 110 deploys instances of an object to compute cluster 140 (operation 350).

Sequence 300 illustrates that node management service 120 obtains new compute nodes 150 for compute cluster 140 (i.e., at operations 315, 320, 325, 330, 335) prior to orchestration service 110 attempting to schedule newly created instances. As such, by the time orchestration service 110 attempts to schedule instances to compute nodes, compute cluster 140 already contains compute nodes 150 that are sufficient to accommodate the instances.

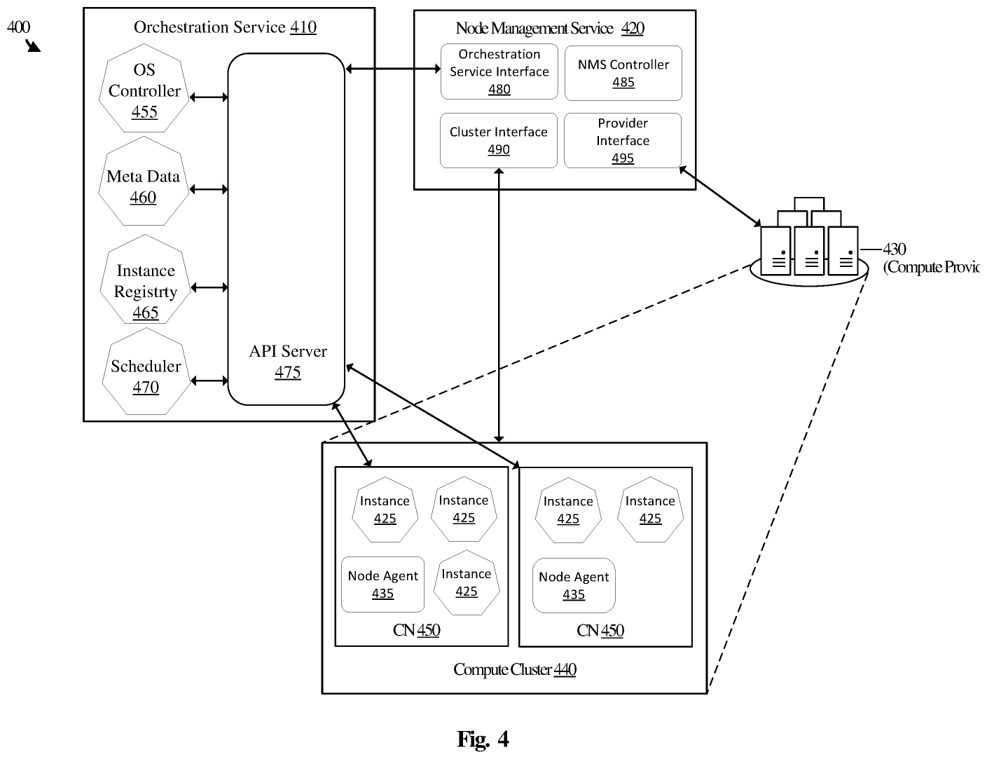

FIG. 4 illustrates compute environment 400 in an implementation. Compute environment 400 includes orchestration service 410, node management service 420, compute provider 430, and compute cluster 440.

Orchestration service 410 orchestrates the scaling and deployment of instances 425 of objects in compute cluster 440. Orchestration service 410 may be Kubernetes or another similar container orchestration platform. Orchestration service 410 includes orchestration service controller (OS controller 455), meta data 460, instance registry 465, scheduler 470, and API server 475.

Application Programming Interface server (API server 475) provides an interface for the elements of orchestration service 410 to communicate with each other (e.g., facilitating communication between OS controller 455 and meta data 460). API server 475 further provides an interface for elements of orchestration service 410 to communicate with external services (e.g., facilitating communication between OS controller 455 and compute cluster 440; and between meta data 460 and orchestration service interface 480).

API server 475 is in communication with OS controller 455, meta data 460, instance registry 465, scheduler 470, compute nodes 450, and orchestration service interface 480 (discussed further below). API server may, in some implementations, also be in communication with compute provider 430. API server 475 may include multiple APIs facilitating communication between the communicating elements in FIG. 4.

OS controller 455 of orchestration service 410 manages the scaling and deployment of instances 425 in compute cluster 440. OS controller 455 determines a number of instances of an object to run in compute cluster 440. In some implementations, the object is a pod having one or more software containers, and the number of instances is a desired number of replicas to run in compute cluster 440. OS controller 455 may determine the number of instances 425 based on usage statistics received from compute cluster 440. Once OS controller 455 determines the number of instances, OS controller 455 updates the meta data 460 to include the determined number of instances. Meta data 460 may include, for example, Kubernetes ReplicaSet meta data.

OS controller 455 scales the instances 425 running in compute cluster 440 to match the determined number of instances. Where the determined number of instances exceeds the number of instances 425 currently running in the compute cluster 440, OS controller 455 creates new instances. Creation of new instances may include adding a dataset for each instance to instance registry 465, where the dataset may include, for example, a unique identification of the instance, a pointer to the object to be replicated, the amount of compute resource to accommodate the instance as defined in object specifications, among other parameters. OS controller creates the new instances to achieve the desired number of instances as defined in meta data 460. Once instances are scheduled (i.e., by scheduler 470 as discussed below) OS controller 455 deploys scheduled instances to compute nodes 450 in compute cluster 440.

Meta data 460 includes data associated with the orchestration of compute cluster 440. Meta data 460 includes a desired number of instances of the object (defined, for example, in Kubernetes ReplicaSet) determined by OS controller 455 as discussed above. Meta data 460 is provided to node management service 420, which uses meta data 460 to make node scaling determinations.

Instance registry 465 is a value store containing a dataset for each instance running in compute cluster 405. Information about each instance may include a unique identification of the instance, specifications for the software containers in the instance, among other parameters. Instance registry further includes the status of each instance. The status may be “pending”, for example, after OS controller 455 adds the instance to instance registry 465 but before scheduling. The status may be “scheduled” after scheduler 470 schedules the instance to a compute node. The status may be “running” when the instance has been successfully deployed to a compute node 450. Where there is a substantial increase in the desired number of instances defined in meta data 460, it may take a long time for OS controller 455 to add all of the instances to instance registry 465. For example, when there are 10,000 to 40,000 new instances, it may take up to forty minutes or more to add all of the instances to instance registry 465.

Scheduler 470 schedules the pending instances in instance registry 465. Scheduling the instances includes matching the instances with compute nodes 450 that have sufficient compute resources available for running the respective instances. Once scheduler 470 schedules the instances, scheduler updates instance registry 465 with the node matches for each instance.

Node management service 420 includes orchestration service interface 480, node management service controller (NMS controller 485), cluster interface 490, and provider interface 495.

Orchestration service interface 480 interfaces with orchestration service 410, and more specifically with API Server 475. Orchestration service interface 480 receives data from meta data 460, including the desired number of instances and the computing resources to accommodate each instance. Orchestration service interface 480 also provides orchestration service 410 with identifications of compute nodes 450 in compute cluster 440 available for running instances of the object.

Node management service controller (NMS controller 485) manages the scaling and usage of compute nodes 450 in compute cluster 440 to provide an appropriate amount of compute resources for instances of the object in compute cluster 440. NMS controller 485 may determine, based on the desired number of instances read from meta data 460, that compute cluster 440 does not have sufficient compute resources to accommodate the desired number of instances. Upon making this determination, NMS controller 485 determines a number of new compute nodes to scale to accommodate the desired number of instances. NMS controller 485 also determines a size of the new compute nodes to accommodate the instances, where the size refers to the amount of compute resources (e.g., CPU, GPU and memory resources) in the compute node. The determination of the number and size of new compute nodes is based on the number of instances of the object read from meta data 460 and the computing requirements of the object.

Provider interface 495 interfaces with compute provider 430. Provider interface 495 obtains new compute nodes for compute cluster 440 by making requests to compute provider 430. Specifically, provider interface 495 submits, to compute provider 430, requests for identifications of VMs available for inclusion in compute cluster 440. The requests may indicate a number and size of VMs corresponding to the number and size of nodes determined by NMS controller 485. Provider interface 495 receives, from compute provider 430 in response to the submitted requests, identifications of VMs available for inclusion in compute cluster 440.

Compute provider 430 provides compute resources. Compute provider 430 may operate data centers in various geographic locations. Compute provider 430 provides users with VMs for running their applications (e.g., on the cloud). Compute provider 430 receives requests for VMs from provider interface 495 and responds with identifications of VMs to be included in compute cluster 440.

Compute cluster 440 includes compute nodes 450. While two compute nodes 450 are shown in FIG. 4 for convenience, compute cluster 440 may include more compute nodes 450. For example, a compute cluster 440 running a large-scale application may include thousands of compute nodes 450. Compute cluster 440 may be, for example, a Kubernetes cluster. A compute node 450 runs node agent 435 and one or more instances 425.

Compute node 450 may be a VM provided by compute provider 430. Compute node 450 runs node agent 435 and one or more instances 425 of an object. Orchestration service 410 initializes compute node 450 by causing node agent 435 to run on compute node (where node agent 435 may be, for example, Kubelet). Node agent 435 performs various functions including monitoring instances 425 running on compute node 450, including registering the respective compute node 450 with API server 475, and monitoring the performance of instances 425 in the respective compute node 450. One or more instances 425 of the object may run on each compute node 450.

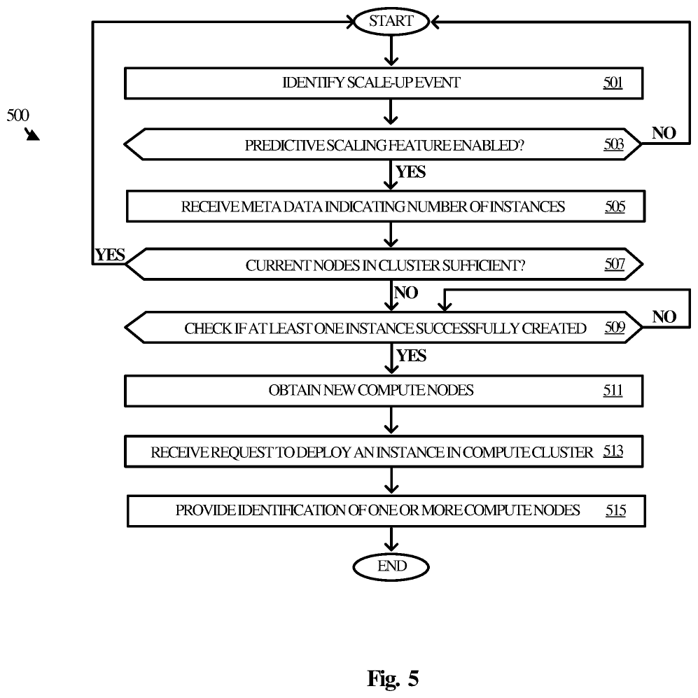

FIG. 5 illustrates a node scaling process performed by node management service 420, represented by process 500. Process 500 is employed by a computing device to provide node scaling, an example of which is provided by computing system 801 of FIG. 8. Process 500 may be implemented in program instructions (software and/or firmware) by one or more processors of the computing device. The program instructions direct the computing device to operate as follows, referring parenthetically to the steps in FIG. 5.

To begin, node management service 420 identifies a scale-up event (step 501). A scale-up event may be identified, for example, based on increased workload in compute cluster 440, or a release of an updated version of an application for deployment in compute cluster 440.

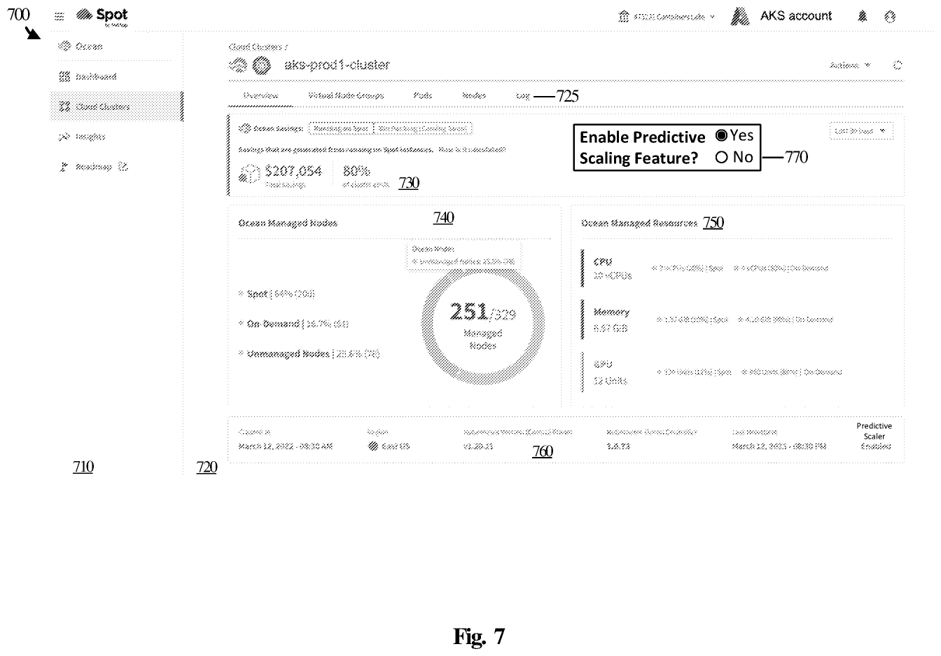

Node management service 420 determines if a predictive scaling feature is enabled for compute cluster 440 (step 503). Node management service 420 makes the determination, for example, by checking configuration settings for compute cluster 440 set by the application owner. The owner may enable the predictive-scale up feature via a user interface provided to the owner of the application (e.g., user interface 700 of FIG. 7). If the feature is not enabled, process 500 returns to the start of process 500, where step 501 is executed upon the occurrence of the next scale-up event.

If the feature is enabled, node management service 420 receives meta data indicating a desired number of instances of an object defined in meta data 460 of orchestration service 410 (step 505). Receiving the meta data may be in response to node management service 420 submitting a request for the meta data to API server 475. The desired number of instances may be defined, for example, in Kubernetes ReplicaSet. The meta data may further indicate the compute requirements for the object defined in object specifications.

Node management service 420 then determines if the current compute nodes in compute cluster 440 are sufficient to accommodate the desired number of instances (step 507). The determination is based on the number instances of the object and the compute requirements of the object. The determination is further based on the available compute resources in current compute nodes 450 of compute cluster 440. For example, each instance may require a specific amount of CPU, GPU and memory resources. If a compute node 450 has a sufficient amount of compute resources to meet the requirements of an instance, the instance may be scheduled to compute node 450. If the current compute nodes in compute cluster 440 are sufficient to accommodate all the desired number of instances, process 500 returns to the start of process 500, where step 501 is executed upon the occurrence of the next scale-up event.

If the current compute nodes in compute cluster 440 are insufficient to accommodate all the desired number of instances, (i.e., the current compute nodes 450 to not have enough free compute resources to run all of the instances) node management service 420 checks if at least one instance has been successfully created by orchestration service 110 (step 509). Checking if at least one instance has been successfully created may include, for example, checking if an instance has been successfully added to instance registry 465. In some cases, orchestration service 110 may not be able to create instances. The inability to create instances may be due, for example, to configuration errors of the object. Configuration errors may include, for example, syntax errors in configuration files, using the wrong identification for a container image, or missing fields in object definitions. Step 509 serves as a protection against proactively scaling up new compute nodes when the instances can't be created for various reasons such as the reasons set forth above. If at least one instance has not yet been created, process 500 returns to step 509 to recheck if an instance has been successfully created.

If at least one instance has been successfully created, node management service 420 obtains new compute nodes from compute provider 430 (step 511). Step 511 may include determining a number and size for the new compute nodes based on the number of instances of the object defined in the meta data and the computing requirements for the object. Step 511 may further include submitting a request for identifications of VMs to compute provider 430 (corresponding to the determined number and size of the new compute nodes), and receiving, from compute provider 430, identifications of VMs available for inclusion in compute cluster 440. Obtaining the new compute nodes may further include running node agent 435 on each VM obtained from compute provider 430. Node agent 435 (such as Kubelet) is responsible for managing the state of instances 425 in the respective compute node 450, including starting containers within each instance 425, and monitoring the status of containers within each instance 425.

After obtaining the new compute nodes, node management service 420 receives, from orchestration service 410, a request to deploy an instance in compute cluster 440 (step 513).

In response to the request, node management service 420 provides orchestration service 410 with an identification of one or more of the new compute nodes which is available to accommodate the instance (step 515). Once orchestration service 410 receives the identifications of the new compute nodes, scheduler 470 schedules new created instances to available compute nodes 450, and OS Controller 455 deploys the instances to their scheduled compute nodes 450.

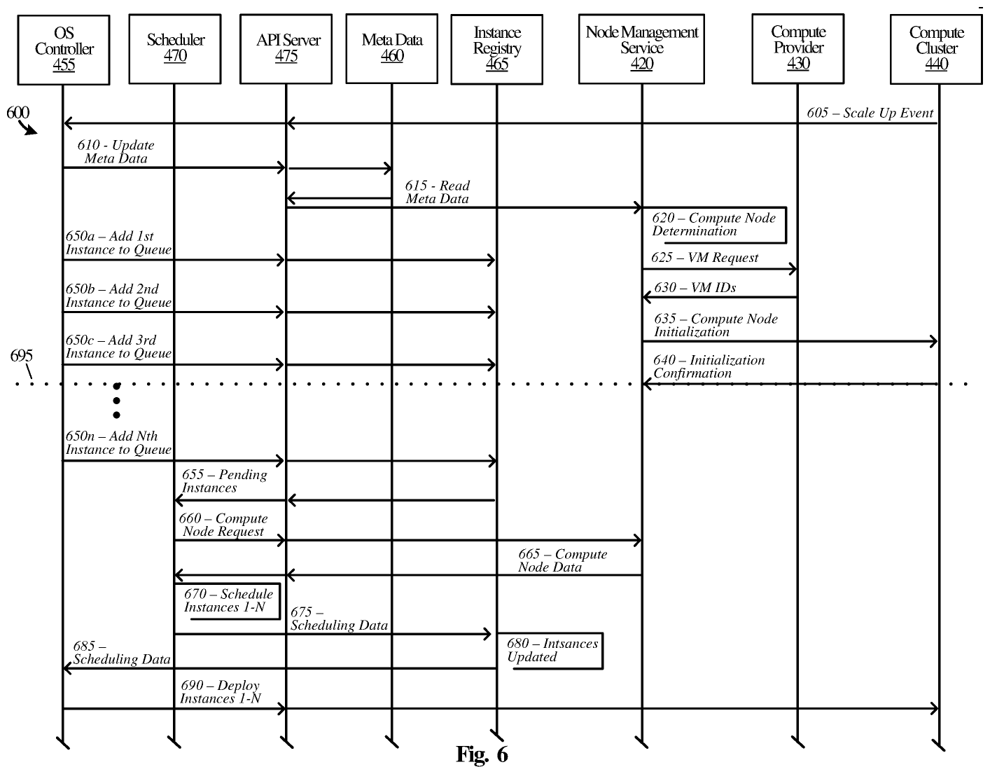

FIG. 6 illustrates an operation sequence in the context of compute environment 400 in an implementation, represented by sequence 600.

To begin, OS Controller 455 receives an indication of a scale-up event from compute cluster 140 (operation 605). A scale-up event may be identified, for example, based on increased workload in compute cluster 440, or a release of an updated version of an application for deployment in compute cluster 440. As demonstrated FIG. 5, this and other operations in operation sequence 600 are performed via API server 475.

In response to the scale-up event, OS Controller 455 updates meta data 460 (operation 610). Updating meta data 460 may include increasing the number of desired instances of an object in response to the scale-up event. Node management service 420 reads the meta data 460, including the desired number of instances (operation 615). Node management service 420 reads meta data 460 by submitting a request for the meta data to API server 475.

In response to reading meta data, node management service 420 determines a number and size of new compute nodes to accommodate the desired number of instances in compute cluster 440 (operation 620). Node management service 420 submits a request to compute provider 430 indicating a number and size of VMs to obtain corresponding to the determined number and size of new compute nodes (operation 625). The request may specify, for each VM requested, the VM type, the VM size, and the Operating System image, among other settings. Compute provider 430 responds to the request of node management service 420 with identifications of VMs available for inclusion in compute cluster 440 (operation 630). Specifically, compute provider 430 provides node management service 420 with identifications of VMs provisioned according to the requirements of the request.

Node management service 420 initializes compute nodes in compute cluster 440 (operation 635). Initializing new compute nodes 150 may include, for example, registering each of the provisioned VMs with compute cluster 140 and deploying a node agent to run in each of the VMs. Node management service 420 receives a confirmation of successful initialization from compute cluster 440 (operation 640). The confirmation of initialization may include an indication that the new compute nodes 140 are initialized and ready to run object instances.

The OS controller 455 adds instances of the object to instance registry 465 to accommodate the desired number of instances in meta data 460 (operations 650a, 650b, 650c, 650n). As demonstrated in FIG. 5, OS controller 455 adds N instances to instance registry 465. For large-scale deployments, N may be a substantial number (e.g., tens of thousands). In such cases, it can take a significant amount of time (e.g., up to 40 minutes or more) for OS controller 455 to add all the N instances to instance registry 465. Adding a large number of instances to instance registry 465 may be a time-intensive process for several reasons. First, a separate data set (including, e.g., a unique identification, a timestamp indicating the time of creation, and a status indicator) is created for each instance. Second, API server 475 validates each instance before adding it to instance registry 465 to ensure proper formatting and that required fields are included. Third, API server 375 may throttle incoming requests to prevent overloading. Furthermore, various other factors may contribute to the length of time it takes to add instances to instance registry 465.

As demonstrated in FIG. 5, node management service 420 may obtain the new compute nodes (in operations 620, 625, 630, 640) before OS controller 455 has finished adding new instances to instance registry 465 (i.e., before OS controller 455 has added the Nth instance to instance registry 465 at operation 650n). Node management service 420 achieves this by reading the meta data at operation 615 and proactively obtaining compute nodes 450 as discussed above. Thus, compute cluster 440 includes sufficient compute resources for scheduling the instances as discussed below.

Scheduler 470 reads data in instance registry 465 to determine which created instances are pending and need to be scheduled (operation 655). Scheduler 470 submits a request to node management service 420 for information about compute nodes in compute cluster 440 (operation 660). Node management service 420 responds to the request with information about the compute nodes, including identifications of compute nodes in compute cluster 440 and the computing resources available on each compute node (operation 665). Scheduler 470 utilizes the information to schedule created instances in instance registry 465. Scheduling includes assigning each instance to a compute node 450 in compute cluster 440 (operation 670). Scheduler 470 provides the scheduling data (i.e., the compute node assigned to each instance) to instance registry 465 (operation 675) to update the instances in instance registry 465 with indications of the assigned compute node 450 for each instance (operation 680). OS controller 455 reads the scheduling data from instance registry 465, including the assigned compute node for each instance (operation 685). OS controller 455 deploys each instance to its assigned compute node (operation 690).

Dotted line 695 represents the point in time in which node management service 420 receives a confirmation from compute cluster 440 (where in FIG. 6, time proceeds generally in the downward direction). FIG. 6 thus demonstrates that node management service 420 obtains the compute nodes (i.e., at operations 620, 625, 635 and 640) prior to OS Controller 455 having successfully added all instances to instance registry 465 (i.e., prior to OS Controller 455 adding the Nth instance to instance registry 465 at operation 650n). Further, node management service 420 obtains the compute nodes prior to scheduler 470 scheduling the instances at operation 670. As a result, when scheduler 470 submits a compute request at operation 660, compute cluster 440 already includes sufficient compute resources to accommodate the instances in instance registry 465.

In previous systems, node scaling systems obtained compute nodes for compute clusters once a scheduler was unable to schedule an instance due to lack of sufficient compute resources in the cluster. As such previous systems experienced the delay in the scaling up of new compute nodes in addition to the initial delay caused by the creation of new instances. In the presently disclosed system, as demonstrated in sequence 600, the proactive scaling up of new compute nodes prevents an additional delay for node scaling after the instances have already been created (i.e., after the Nth instance has been added to instance registry 465 at operation 650n).

FIG. 7 illustrates user interface 700 provided to application owners in an implementation. User interface 700 may be generated and provided to application owners by a node management service such as node management service 120 of FIG. 1 or node management service 420 of FIG. 4.

User interface 700 includes panel 710 and display 720, in an implementation. Panel 710 provides a list of different selectable services. In the example in FIG. 7, an owner has selected “cloud clusters” (referring, for example, to compute cluster 140 of FIG. 1 or compute cluster 440 of FIG. 4). Display 720 provides information and configuration options to the owner, in one implementation. In the example in FIG. 7, display 720 includes selectable tabs 725, savings overview 730, node overview 740, resource overview 750, high-level overview 760, and feature selection option 770. It is noted that user interface 700 is exemplary; user interfaces in other implementations may have different views and arrangements.

Selectable tabs 725 are selectable by the owner for viewing information about various features of a compute cluster (e.g., compute cluster 140 of FIG. 1 or compute cluster 440 of FIG. 4). In the example in FIG. 7, the owner has selected “Overview,” resulting in the display of savings overview 730, node overview 740, and resource overview 750.

Savings overview 730 displays savings to the owner resulting from usage of the node management service (e.g., node management service 120 of FIG. 1 or node management service 420 of FIG. 4).

Node overview 740 displays a breakdown of the nodes in the compute cluster. Specifically, node overview 740 indicates how many nodes are managed by the node management service (e.g., node management service 120 of FIG. 1 or node management service 420 of FIG. 4).

Resource overview 750 displays the resources managed by the node management service (e.g., node management service 120 of FIG. 1 or node management service 420 of FIG. 4) including CPUs (Central Processing Units), Memory, and GPUs (Graphics Processing Units).

High-level overview 760 provides high level information about the compute cluster (e.g., compute cluster 140 of FIG. 1 or compute cluster 440 of FIG. 4), the orchestration service (e.g., orchestration service 110 of FIG. 1 or orchestration service 410 of FIG. 4) and the node management service (e.g., node management service 120 of FIG. 1 or node management service 420 of FIG. 4).

Feature selection option 770 provides the owner with the option to enable or disable a predictive scaling feature, where the predictive scaling feature may be an optional feature of the node management service (e.g., node management service 120 of FIG. 1 or node management service 420 of FIG. 4). The predictive scaling feature may be represented, for example, steps 201-207 of process 200 in FIG. 2, or steps 505-515 of process 500 in FIG. 5. The decision at step 503 in FIG. 5 may be based on whether the owner has enabled or disabled the predictive scaling feature via feature selection option 770. Specifically, process 500 proceeds to step 505 if the owner has selected “Yes” within feature selection option 770; and process 500 returns to step 501 if the owner has selected “NO” within feature selection option 770.

FIG. 8 illustrates computing system 801, which is representative of any system or collection of systems in which the various applications, processes, services, and scenarios disclosed herein may be implemented. Examples of computing system 801 include, but are not limited to server computers, web servers, cloud computing platforms, and data center equipment, as well as any other type of physical or virtual server machine, container, and any variation or combination thereof. (In some examples, computing system 801 may also be representative of desktop and laptop computers, tablet computers, and the like.)

Computing system 801 may be implemented as a single apparatus, system, or device or may be implemented in a distributed manner as multiple apparatuses, systems, or devices. Computing system 801 includes, but is not limited to, processing system 802, storage system 803, software 805, communication interface system 807, and user interface system 809. Processing system 802 is operatively coupled with storage system 803, communication interface system 807, and user interface system 809.

Processing system 802 loads and executes software 805 from storage system 803. Software 805 includes and implements node scaling process 806, which is representative of the processes discussed with respect to the preceding Figures, such as processes 200 and 500. When executed by processing system 802, software 805 directs processing system 802 to operate as described herein for at least the various processes, operational scenarios, and sequences discussed in the foregoing implementations. Computing system 801 may optionally include additional devices, features, or functionality not discussed for purposes of brevity.

Referring still to FIG. 8, processing system 802 may include a microprocessor and other circuitry that retrieves and executes software 805 from storage system 803. Processing system 802 may be implemented within a single processing device but may also be distributed across multiple processing devices or sub-systems that cooperate in executing program instructions. Examples of processing system 802 include general purpose central processing units, microcontroller units, graphical processing units, application specific processors, integrated circuits, application specific integrated circuits, and logic devices, as well as any other type of processing device, combinations, or variations thereof.

Storage system 803 may comprise any computer readable storage media readable by processing system 802 and capable of storing software 805. Storage system 803 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal. Storage system 803 may be implemented as a single storage device but may also be implemented across multiple storage devices or sub-systems co-located or distributed relative to each other. Storage system 803 may comprise additional elements, such as a controller capable of communicating with processing system 802 or possibly other systems.

Software 805 (including node scaling process 806) may be implemented in program instructions and among other functions may, when executed by processing system 802, direct processing system 802 to operate as described with respect to the various operational scenarios, sequences, and processes illustrated herein. For example, software 805 may include program instructions for implementing node scaling processes and procedures as described herein.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, and describes the best mode contemplated, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for”, but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

The phrases “in some embodiments,” “according to some embodiments,” “in the embodiments shown,” “in other embodiments,” and the like generally mean the particular feature, structure, or characteristic following the phrase is included in at least one implementation of the present technology and may be included in more than one implementation. In addition, such phrases do not necessarily refer to the same embodiments or different embodiments.

What is claimed is:

1. A method of operating a node management service, the method comprising:
receiving, from an orchestration service, meta data indicating a number of instances of an object to scale up with respect to an application deployed on compute nodes in a compute cluster, the compute nodes being provided by a compute provider and managed by the node management service; and
proactively obtaining, based on the number of instances indicated in the meta data, one or more new compute nodes from the compute provider.

2. The method of claim 1 further comprising:
after obtaining the new compute nodes, receiving a request from the orchestration service to deploy at least an instance of the object in the compute cluster; and
providing, to the orchestration service in response to the request, an identification of one of the one or more new compute nodes on which to deploy the instance of the object.

3. The method of claim 2 wherein, to scale up the application, the orchestration service determines the number of instances of the object to scale up, edits the meta data to reflect the number of the instances, and adds the instances into an instance registry, from where the instances are scheduled for deployment to the compute cluster.

4. The method of claim 3 wherein obtaining the new compute nodes occurs prior to any of the instances being scheduled for deployment and prior to the orchestration service having added all of the instances to the instance registry.

5. The method of claim 4, further comprising:
determining that the orchestration service has successfully created at least one instance corresponding to the number of instances, wherein the obtaining the one or more new compute nodes is in response to determining that the orchestration service has successfully added at least one instance to the instance registry.

6. The method of claim 1 further comprising:
predicting, based on the number of instances indicated in the meta data, that current compute nodes in the compute cluster are not sufficient to accommodate the instances, wherein the obtaining the one or more new compute nodes is in response to determining that the current compute nodes are not sufficient.

7. The method of claim 1 further comprising:
generating a user interface for display to an owner of the application, wherein the user interface comprises an element allowing the owner to enable a predictive scaling feature of the node management service, wherein the predictive scaling feature includes the obtaining the one or more new compute nodes based on the number of objects.

8. A system for operating a node management service, the system comprising:
one or more processors; and
one or more memories operably coupled to the one or more processors and having stored thereon software instructions that, upon execution by the one or more processors, cause the one or more processors to:
receive, from an orchestration service, meta data indicating a number of instances of an object to scale up with respect to an application deployed on compute nodes in a compute cluster, the compute nodes being provided by a compute provider and managed by the node management service;
obtain, from the compute provider, one or more new compute nodes for the compute cluster based on the number of instances indicated in the meta data;
after obtaining the new compute nodes, receive a request from the orchestration service to deploy at least an instance of the object in the compute cluster; and
provide, to the orchestration service in response to the request, an identification of one of the one or more new compute nodes on which to deploy the instance of the object.

9. The system of claim 8, wherein, to scale up the application, the orchestration service determines the number of instances of the object to scale up, edits the meta data to reflect the number of the instances, and adds the instances into an instance registry, from where the instances are scheduled for deployment to the compute cluster.

10. The system of claim 9, wherein obtaining the new compute nodes occurs prior to any of the instances being scheduled for deployment and prior to the orchestration service having added all of the instances to the instance registry.

11. The system of claim 9, wherein the software instructions comprise further instructions that, upon execution by the one or more processors, cause the one or more processors to:
determine that the orchestration service has successfully created at least one object corresponding to the number of objects, wherein the obtaining the one or more new compute nodes is in response to determining that the orchestration service has successfully added at least one instance to the instance registry.

12. The system of claim 8, wherein the software instructions comprise further instructions that, upon execution by the one or more processors, cause the one or more processors to:
predict, based on the number of objects indicated in the meta data, that current compute nodes in the compute cluster are not sufficient to accommodate the instances, wherein the obtaining the one or more new compute nodes is in response to determining that the current compute nodes are not sufficient.

13. The system of claim 8, wherein the software instructions comprise further instructions that, upon execution by the one or more processors, cause the one or more processors to:
generate a user interface for display to an owner of the application, wherein the user interface comprises an element allowing the owner to enable a predictive scaling feature of the node management service, wherein the predictive scaling feature includes the obtaining the one or more new compute nodes based on the number of objects.

14. The system of claim 8, wherein the orchestration service comprises Kubernetes, wherein the compute cluster comprises a Kubernetes cluster, and wherein the number of instances corresponds to a desired number of pod replicas in the Kubernetes cluster.

15. A computer-readable storage media having program instructions stored thereon to operate a node management service, wherein the program instructions, upon execution by one or more processors, cause the one or more processors to:
generate a user interface for display to an owner of an application deployed on compute nodes in a compute cluster, the compute nodes being provided by a compute provider and managed by the node management service, wherein the user interface comprises an element allowing the owner to enable a predictive scaling feature of the node management service;
in response to a scale-up event, determine whether the predictive scaling feature is enabled for the application; and
in response to determining that the predictive scaling feature is enabled for the application, apply the predictive scaling feature to the application.

16. The computer-readable storage media of claim 15 wherein the program instructions further cause the one or more processors to:
receive, from an orchestration service, meta data indicating a number of instances of an object to scale up with respect to the application;
obtain, from the compute provider, one or more new compute nodes for the compute cluster based on the number of instances indicated in the meta data;
after obtaining the new compute nodes, receive a request from the orchestration service to deploy at least an instance of the object in the compute cluster; and
provide, to the orchestration service in response to the request, an identification of one of the one or more new compute nodes on which to deploy the instance of the object.

17. The computer-readable storage media of claim 16 wherein, to scale up the application, the orchestration service determines the number of instances of the object to scale up, edits the meta data to reflect the number of the instances, and adds the instances into an instance registry, from where the instances are scheduled for deployment to the compute cluster, and wherein obtaining the new compute nodes occurs prior to any of the instances being scheduled for deployment and prior to the orchestration service having added all of the instances to the instance registry.

18. The computer-readable storage media of claim 17 wherein the program instructions further cause the one or more processors to:
determine that the orchestration service has successfully created at least one object corresponding to the number of objects, wherein the obtaining the one or more new compute nodes is in response to determining that the orchestration service has successfully added at least one instance to the instance registry.

19. The computer-readable storage media of claim 18 wherein the program instructions further cause the one or more processors to:
predict, based on the number of instances indicated in the meta data, that current compute nodes in the compute cluster are not sufficient to accommodate the number of instances, wherein the obtaining the one or more new compute nodes is in response to determining that the current compute nodes are not sufficient.

20. The computer-readable storage media of claim 16 wherein the orchestration service comprises Kubernetes, wherein the compute cluster comprises a Kubernetes cluster, and wherein the number of instances corresponds to a desired number of pod replicas in the Kubernetes cluster.
